(19) United States
(12) Patent Application Publication
(10) Pub. No.: US 2007/0150507 A1
(43) Pub. Date: Jun. 28, 2007

(54) System for a configurable open database connectivity conduit

(76) Inventors: Joseph Nardone, Arlington, VA (US); Jeffrey Phelps, Fairfax, VA (US); Mark Wallace, Burke, VA (US)

Correspondence Address: MANELLI DENISON & SELTER PLLC, 7th FLOOR, 2000 M STREET, N.W.,, WASHINGTON, DC, DC, 20036-3307, US

(21) Appl. No.: 11/701,366

(22) Filed: Feb. 2, 2007

Related U.S. Application Data
(63) Continuation of application No. 09/985,879, filed on Nov. 6, 2001.
(60) Provisional application No. 60/245,713, filed on Nov. 6, 2000.
(60) Provisional application No. 60/245,677, filed on Nov. 6, 2000.
(60) Provisional application No. 60/245,678, filed on Nov. 6, 2000.

(51) Int. Cl. G06F 7/00

(52) U.S. Cl. 707/102; 707/100

(57) ABSTRACT

A configurable conduit generator module is utilized to generate customizable conduits. The configurable conduit may be configured to provide the synchronization rules between client databases and corresponding enterprise databases. The configurable conduit generator module may be configured to provide a point-and-click environment to create the configurable conduit. In particular, a graphical user interface (GUI) may be presented to the user to select the client database and to select the enterprise database. Another GUI may be presented to provide the mapping of the fields (or columns) from the client database to the enterprise database. The direction of the synchronization may be also be specified. Once the mapping of the fields is created, the mapping file is saved for execution by the configurable conduit during a synchronization event.

### RELATED APPLICATIONS

This application claims priority to U.S. Provisional Application No. 60/245,713, filed Nov. 6, 2000, entitled “Configurable Open Database Connectivity Conduit”, U.S. Provisional Application No. 60/245,677, filed Nov. 6, 2000, entitled “Configurable Open Database Connectivity Conduit”, and U.S. Provisional Application No. 60/245,678, filed Nov. 6, 2000, entitled “Configurable Open Database Connectivity Conduit”, which are assigned to the assignee of this application. The disclosures of application serial Nos. 60/245,713, 60/245,677, and 60/245,678 are incorporated herein by reference.

### FIELD OF THE INVENTION

The invention relates generally to synchronizing data stored on a remote device with data stored in a main computing device. More particularly, the present invention relates to a configurable open database connectivity (ODBC) conduit.

### DESCRIPTION OF THE RELATED ART

It is generally known that remote devices execute applications that may be intermittently interfaced with a corresponding application on an enterprise server (or a local personal computer, workstation, or other similar workstation). In this type of situation, a conventional synchronization program may be utilized to ensure that the data contained on the remote device is updated with any changes to data on the enterprise server. The converse is also true where any changes to data on the remote devices is updated to the enterprise server.

The conventional synchronization program (or utility, subroutine or other programming code) typically manages the process of merging the two databases together. In particular, the conventional synchronization program invokes a conduit to perform the actual data manipulation for each database to be synchronized. There is typically one conduit assigned to each unique pair of remote and enterprise server applications, which is better illustrated in FIG. 9.

FIG. 9 illustrates a conventional system 900 of a client 910 and an enterprise server 920. As shown in FIG. 9, the client 910 may be configured to provide a mobile computing environment for a user to execute software applications. The client 910 may be implemented by a personal digital assistant, a laptop computer, or other similar mobile computing platform. The client 910 may execute software applications that are linked to corresponding software applications on the enterprise server 920. The enterprise server 920 may be implemented by a server, a workstation, or other similar computing platform.

The client 910 may be configured to execute a sync manager 912. The sync manager 912 may be configured to build a list of conduits that are to be executed in response to a synchronization request. As shown in FIG. 9, the sync manager 912 may have built the conduits 914 for each respective application database 916. The sync manager 912 may be further configured to manage the synchronization of the data contained in the application databases 916 with the respective enterprise application databases 922 through a sync server 924 on an enterprise server 920.

The conventional conduit 914 may have the responsibility of: (1) opening the respective databases on the remote device and the enterprise server; (2) determining which records are added, deleted, or modified on both computing platforms and use this information to perform the synchronization; (3) converting data between local and remote formats (e.g., resolve byte-format differences between the platforms (if any); (4) creating and/or deleting local and remote records; and (5) writing information to a synchronization log, if necessary.

In order to create the conduits 914, the development of these conduits 914 typically requires extensive programming knowledge and experience on the part of the developer. A typical developer needs to know the database formats on both platforms and be able to write programming code to map fields from one database to another database. Moreover, for each application, a new conduit has to be developed, which may lead to a delay.

### SUMMARY OF THE INVENTION

In accordance with the principles of the present invention, one aspect of the invention pertains to a method of creating conduits for synchronizations. The method includes generating a first graphical user interface and selecting a first database and a second database on the first graphical user interface. The method also includes mapping at least one field of the first database to a corresponding field of the second database in a map file and linking a conduit with the map file. The method further includes executing the conduit with the map file in response to a synchronization request, where the conduit provides synchronization rules from the map file for the first database and the second database.

Another aspect of the present invention relates to a method of synchronizing databases. The method includes configuring a conduit for synchronization between a first database and a second database and initiating a synchronization request. The method also includes synchronizing the first database and the second database according to the conduit in response to the synchronization request.

Yet another aspect of the present invention pertains to a computer readable storage medium on which is embedded one or more computer programs. The one or more computer programs implement a method of creating conduits for synchronizations. The one or more computer programs include a set of instructions for generating a first graphical user interface and selecting a first database and a second database on the first graphical user interface. The one or more computer programs also include a set of instructions for mapping at least one field of the first database to a corresponding field of the second database in a map file and linking a conduit with the map file. The one or more computer programs further include a set of instructions for executing the conduit with the map file in response to a synchronization request, where the conduit provides synchronization rules from the map file for the first database and the second database.

Yet another aspect of the present invention relates to an apparatus for creating conduits for synchronizations. The apparatus includes means for generating a first graphical user interface and means for selecting a first database and a second database on the first graphical user interface. The apparatus also includes means for mapping at least one field of the first database to a corresponding field of the second database in a map file and means for linking a conduit with the map file. The apparatus further includes means for executing the conduit with the map file in response to a synchronization request, wherein the conduit provides synchronization rules from the map file for the first database and the second database.

### BRIEF DESCRIPTION OF THE DRAWINGS

Various objects, features, and aspects of the present invention can be more fully appreciated as the same become better understood with reference to the following detailed description of the present invention when considered in connection with the accompanying drawings, in which:

FIG. 1 illustrates an exemplary block diagram of a system where an embodiment of the present invention may be practiced;

FIG. 2 illustrates an exemplary block diagram of a developer platform where an embodiment of the present invention may be practiced;

FIG. 3 illustrates an exemplary block diagram of a configurable conduit shown in FIG. 2, in accordance with an embodiment of the present invention;

FIG. 4 illustrates an architecture of the configurable conduit generator module shown in FIG. 3 in accordance with an embodiment of the present invention;

FIG. 5 illustrates an exemplary block diagram of a computing platform where an embodiment of the configurable conduit generator module shown in FIGS. 3 and 4 may be practiced in accordance with the principles of the present invention;

FIG. 6 illustrates an exemplary flow diagram for an embodiment of the configurable conduit generator module shown in FIG. 3 in accordance with the principles of the present invention;

FIGS. 7A-7I collectively depict exemplary embodiments of a graphical user interface utilizable for configuring the configurable conduit generator module in accordance with an embodiment of the present invention;

FIGS. 8A-8C depict an exemplary flow diagram utilizable by the configurable conduit generator module in accordance with the principles of the present invention; and

FIG. 9 illustrates a conventional block diagram of a system that includes a wireless client and an enterprise server.

### DETAILED DESCRIPTION OF A PREFERRED EMBODIMENT

For simplicity and illustrative purposes, the principles of the present invention are described by referring mainly to an exemplary embodiment of a configurable conduit generator module. However, one of ordinary skill in the art would readily recognize that the same principles are equally applicable to, and can be implemented in, all types of systems requiring synchronization, and that any such variation does not depart from the true spirit and scope of the present invention. Moreover, in the following detailed description, references are made to the accompanying drawings, which illustrate specific embodiments in which the present invention may be practiced. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

In accordance with an embodiment of the present invention, a configurable conduit generator module is utilized to generate customizable conduits. The configurable conduit may be configured to provide the synchronization rules between client databases and corresponding enterprise databases. The configurable conduit generator module may be configured to provide a point-and-clink environment to create the configurable conduit. In particular, a graphical user interface (GUI) may be presented to the user to select the client database and to select the enterprise database. Another GUI may be presented to provide the mapping of the fields (or columns) from the client database to the enterprise database. The direction of the synchronization may be also be specified. Once the mapping of the fields is created, the mapping file is saved for execution by the configurable conduit during a synchronization event.

In another aspect, the present invention relates to a configurable conduit. The configurable conduit may be an abstraction of the conventional conduit. In particular, the configurable conduit may be linked to one or more mapping rule sets (or configuration files). Each mapping rule set may define the mapping of the columns (or fields) of a wireless client database to a corresponding enterprise database. The mapping may be predefined or may be user-defined. The configurable conduit may be configured to execute a synchronization according to each linked mapping rule sets. Thus, one conduit may be used for multiple applications as opposed to conventional conduits where a conduit is created for a single application.

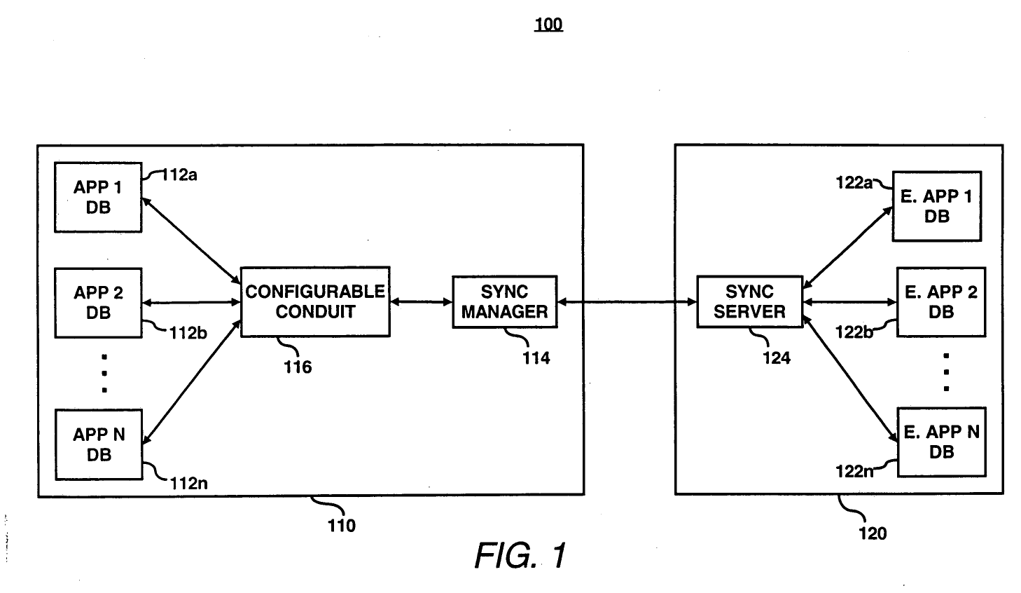

FIG. 1 illustrates a conventional block diagram of a system 100 that includes a client 110 and an enterprise server 120. As shown in FIG. 1, the client 110 may be configured to provide a portable computing platform to execute software applications such as a browser, an electronic mail application, a contacts organizer application, etc. The software applications may also include custom software applications of a business such as ordering programs, inventory programs, etc. Each of the software applications may include application databases 112. Moreover, the software applications may be configured to operate intermittently from respective software application being executed on the enterprise server 120.

The client 110 may be implemented as a two-way text pager, a personal digital assistant (e.g., PALM PILOT series, HEWLETT-PACKARD POCKET PC, etc.), a laptop computer, or other similar mobile computing platforms. The client 110 may be configured to communicate with the enterprise server 120 in a wireless (e.g., infrared, radio-frequency, etc.) or wired (e.g., a dedicated cable, a telephone line, etc.) manner.

The client 110 may be configured to execute a sync manager 114. The sync manager 114 may be configured to manage the synchronization of the data contained in the application databases 112 with the respective enterprise application databases 122 with a sync server 124 on the enterprise server 120.

The enterprise server 120 may be configured to provide a computing environment for the enterprise software applications. The enterprise software applications may include the complementary software applications to the software applications of the client 110 as well as complementary enterprise databases 122 to the application databases 112 of the client 110.

The sync manager 114 of the wireless client may be configured to synchronize the application databases 112 with the respective enterprise databases 122 by utilizing a configurable conduit 116. The configurable conduit 116 may be configured to execute the synchronization of the application databases 112 and the enterprise databases 122. In particular, the configurable conduit 116 may determine which records have been modified, added or deleted and update the changes to the application databases 112 and the enterprise databases 122. The configurable conduit 116 may implement the synchronization by referencing a mapping rule set for each application database. Each mapping rule set may be configured to provide the mapping of columns (or fields) of one database to another database. Thus, the sync manager may execute a single conduit for multiple application databases.

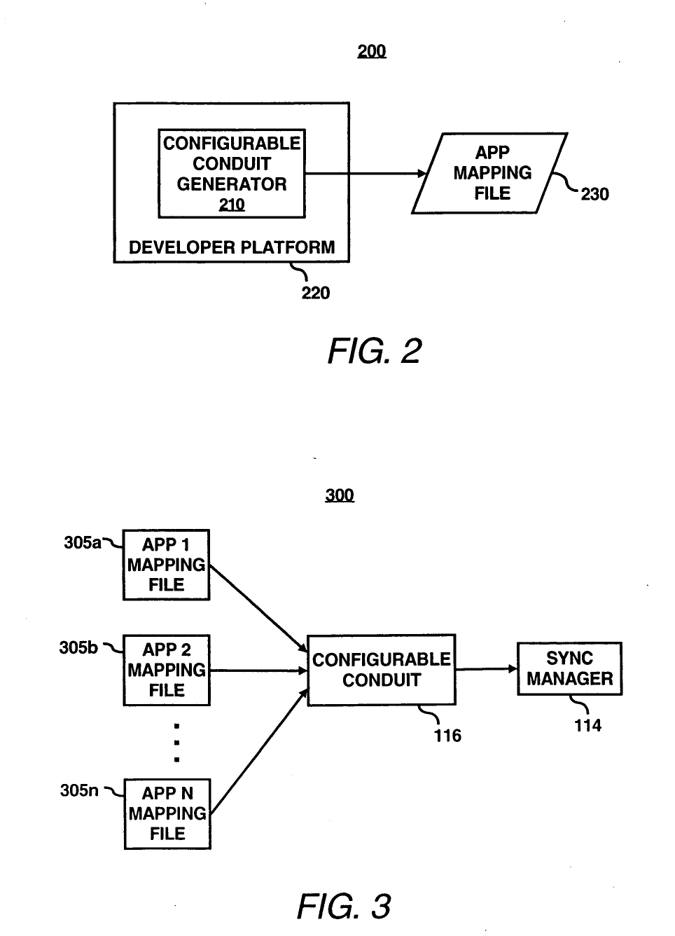

A configurable conduit generator module 210 shown in FIG. 2, which illustrates an exemplary block diagram 200 of a developer platform 220 where an embodiment of the present invention may be practiced, may generate a mapping rule set. As shown in FIG. 2, the system 200 includes the configurable conduit generator module 210 and the developer platform 220.

The configurable conduit generator module 210 may be configured to provide a point-and-clink environment to create a mapping rule set. In particular, the configurable conduit generator module 210 may present a GUI to a user to select the client database and to select the enterprise database. A second GUI may be presented to provide the mapping of the fields (or columns) from the client database to the enterprise database. The direction of the synchronization may be also be specified. A third GUI may be presented for a user to add a customized mapping of one field of one database to another field of the enterprise database or to delete a mapping rule. Once the mapping of the fields is created, a mapping rule set 230 may be saved for execution by the configurable conduit 116 (shown in FIG. 1) during a synchronization event.

The developer platform 220 may be configured to provide an execution environment for a user to create the mapping rule sets. The developer platform 220 may be implemented using a personal computer, a workstation, or other similar computing platforms.

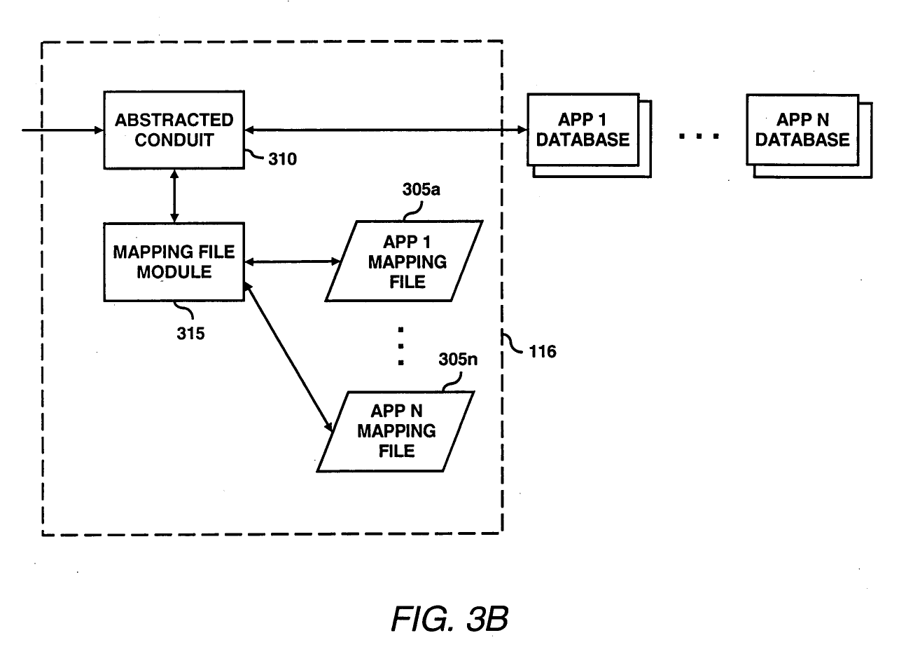

FIG. 3 illustrates an exemplary block diagram 300 of the configurable conduit 116 shown in FIG. 1, in accordance with an embodiment of the present invention. As shown in FIG. 3, the configurable conduit 116 may be programmed to read a plurality of application mapping rule sets (or configuration files) 305. The application mapping rule sets 305 may have been created with the configurable conduit generator module 210 (shown in FIG. 2).

In particular, the configurable conduit 116 may be configured to be a generalized or generic conduit performing functions similar to conventional conduits. However, unlike conventional conduits which are specifically designed for an application, the configurable conduit 116 may be configured to synchronize multiple applications by utilizing the application mapping rule sets 305. Once the mapping rule sets 305 have been defined by a user, the configurable conduit generator module 210 may be configured to program the configurable conduit 116 to read the mapping rule sets 305. This programming may be implemented by using a data-source reference to a directory where the mapping rule sets 305 are stored. Alternatively, the programming may be implemented by point the configurable conduit 116 to a mapping rule set 305 and the first mapping rule set 305 may have a link to the next mapping rule set.

Once the configurable conduit 116 has the application mapping rule sets 305 programmed, the configurable conduit 116 may be configured to perform synchronization according to an application mapping rule set 305, for example, between the respective client database and the respective enterprise database. Accordingly, a single conduit may be executed by the sync manager 114 to synchronize the application databases of the client with the corresponding databases on an enterprise server.

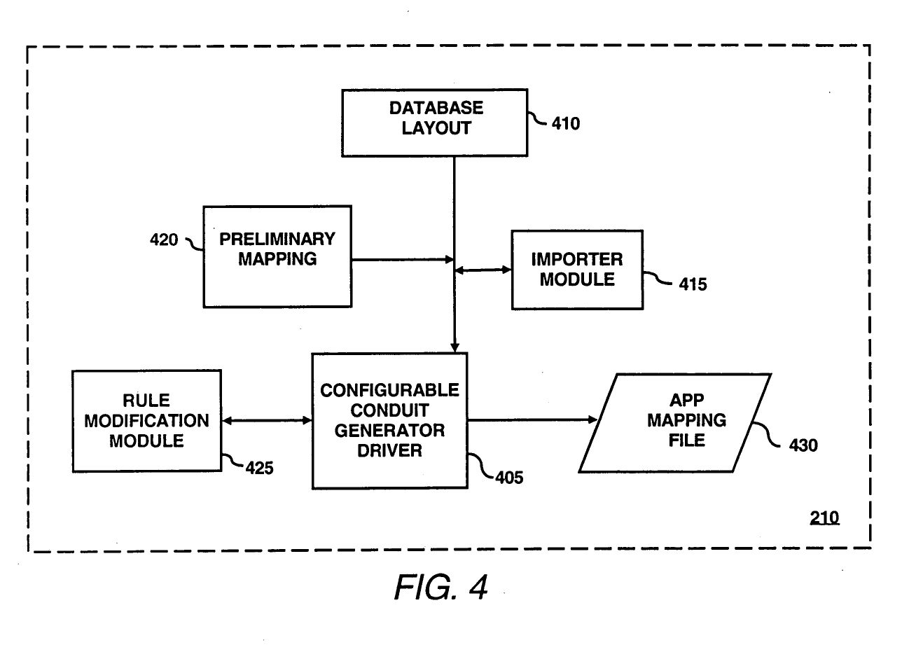

FIG. 4 illustrates an architecture of the configurable conduit generator module 116 shown in FIG. 2 in accordance with an embodiment of the present invention. As shown in FIG. 4, the configurable conduit generator module 116 may include a configurable generator driver module 405 (now referred to as driver module), a database layout module 410, an importer module 415, a preliminary mapping module 420, and a rule modification module 425.

The driver module 405 may be configured to provide program control of the configurable conduit generator module 116. In particular, the driver module 405 may provide the logical infrastructure, i.e., programming constructs, to implement the functionality of the configurable conduit generator module 116 as described herein below and further detailed below.

The driver module 405 may be configured to interface with the database layout module 410. The database layout module 410 may provide for configuration information of databases such as ODBC, PALM databases, user-defined databases, or other similar databases involved in the client/enterprise server systems.

The driver module 405 may be configured to interface with an importer module 415. The importer module 415 may be configured to translate non-native database formats into a format compatible with the configurable conduit generator module 210. The importer module 415 may be implemented as a table that may be modified as necessary to support database format as supplied by database OEM vendors.

The preliminary mapping module 420 of the configurable conduit generator module 116 may be configured to provide preliminary mapping between the fields of two selected databases. In particular, the preliminary mapping module 420 may provide a mapping rule that maps the names of fields (or tables) in a client database with the same name of fields (or columns) in an enterprise database.

The driver module 405 may be further configured to interface with the rule modification module 425. The rule modification module 425 may be configured to provide a mechanism to add user defined mapping of one field of a first database to a corresponding filed of a second database, i.e., a rule. The rule modification module 425 may be also configured to provide a mechanism to delete an existing rule.

The driver module 405 may be further configured to output an application mapping rule file 430. The application mapping rule file 430 may be saved in a persistent memory storage as specified by a user, which is subsequently used by the configurable conduit 116 in a synchronization event.

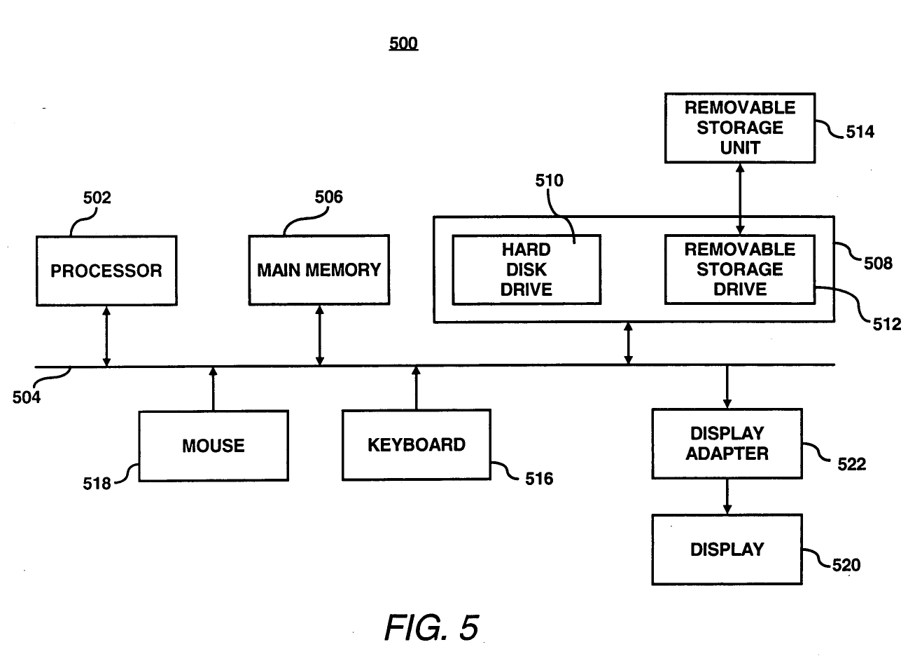

FIG. 5 illustrates an exemplary block diagram of a computing platform 500 where an embodiment of the present invention may be practiced. The functions of the configurable conduit generator module 116 may be implemented in program code and executed by the computing platform 500. The configurable conduit generator module 116 may be implemented in computer languages such as PASCAL, C, C++, JAVA, etc.

As shown in FIG. 5, the computing platform 500 includes one or more processors, such as processor 502 that provides an execution platform for the configurable conduit generator module 116. Commands and data from the processor 502 are communicated over a communication bus 504. The computing platform 500 also includes a main memory 506, preferably Random Access Memory (RAM), where the software for the configurable conduit generator module 116 may be executed during runtime, and a secondary memory 508. The secondary memory 508 includes, for example, a hard disk drive 510 and/or a removable storage drive 512, representing a floppy diskette drive, a magnetic tape drive, a compact disk drive, etc., where a copy of software for the configurable conduit generator module 116 may be stored. The removable storage drive 512 reads from and/or writes to a removable storage unit 314 in a well-known manner. A user interfaces the configurable conduit generator module 116 with a keyboard 516, a mouse 518, and a display 520. The display adaptor 522 interfaces with the communication bus 504 to receive display data from the processor 502 and converts the display data into display commands for the display 520.

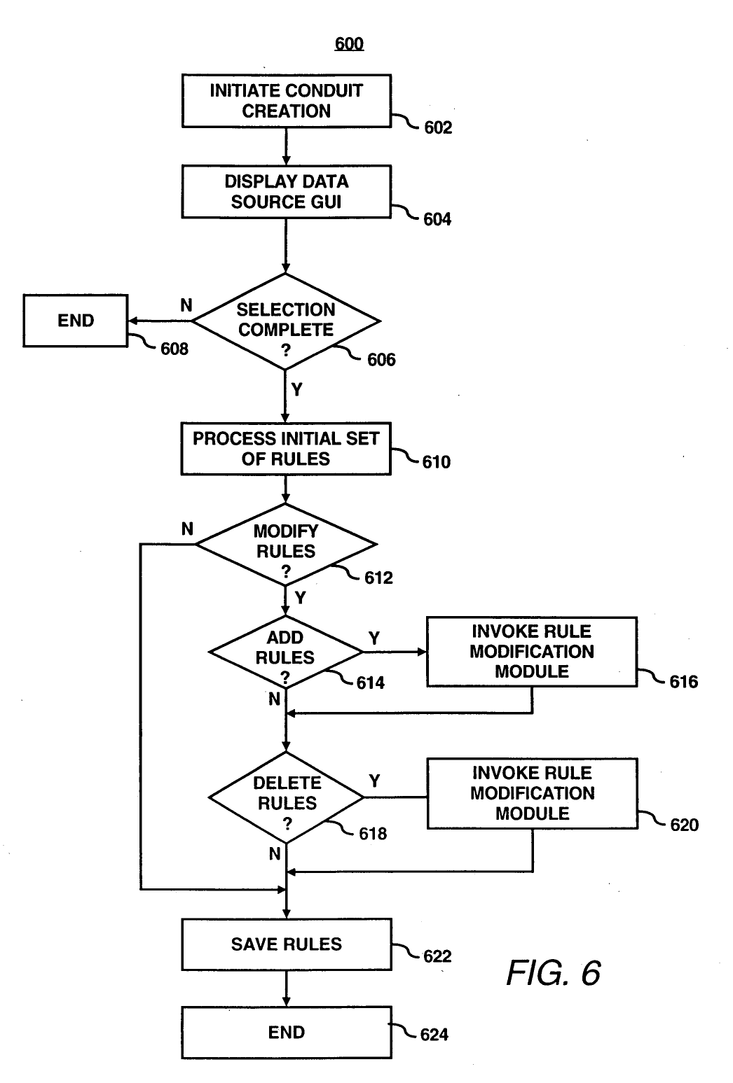

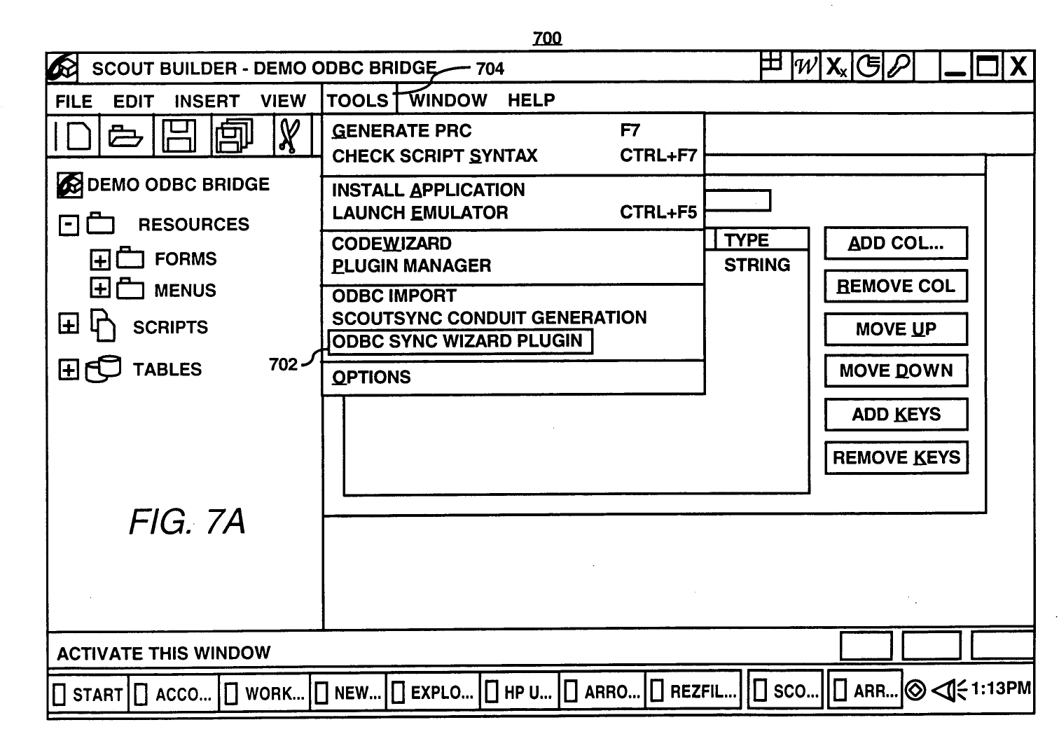

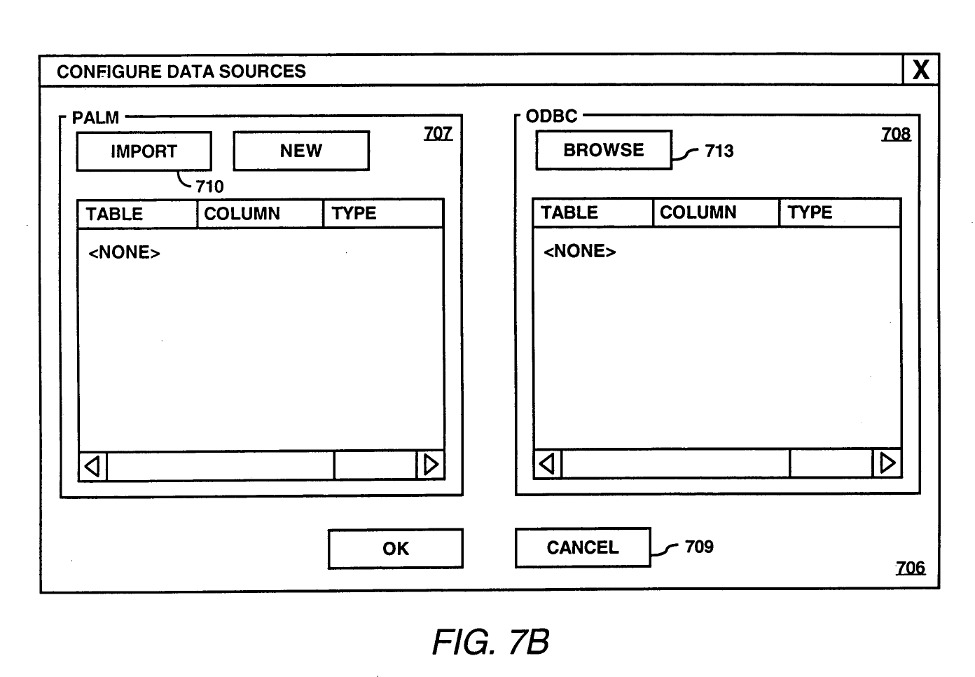

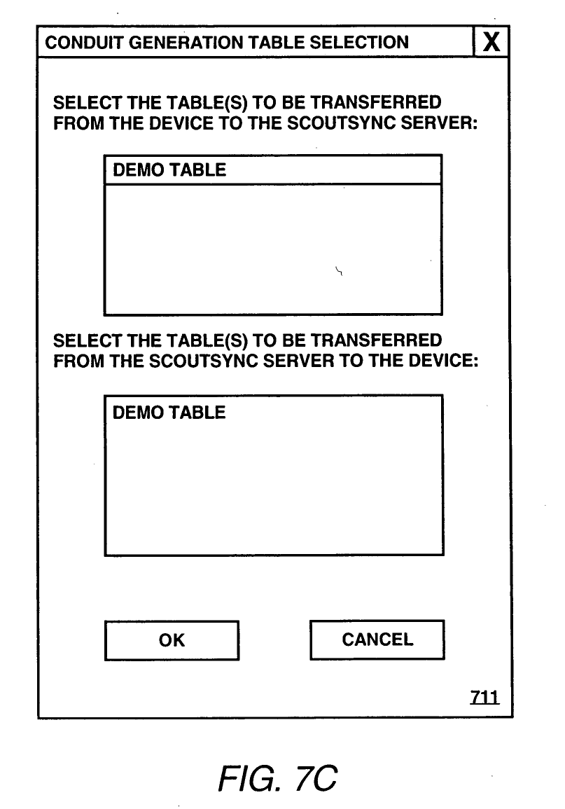

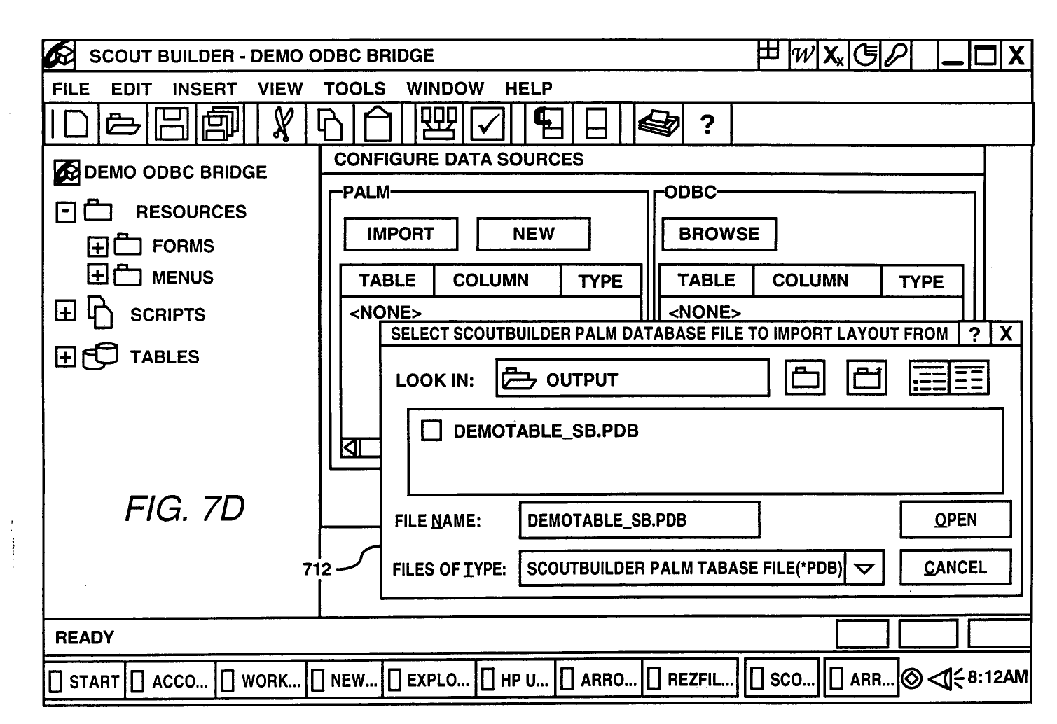

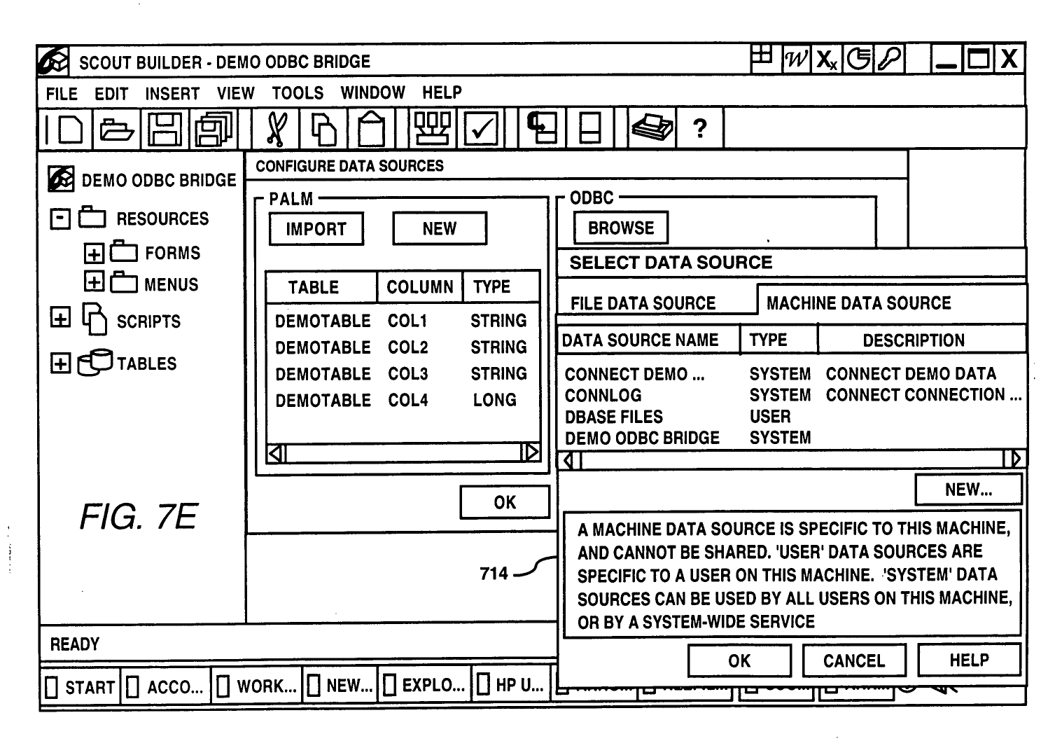

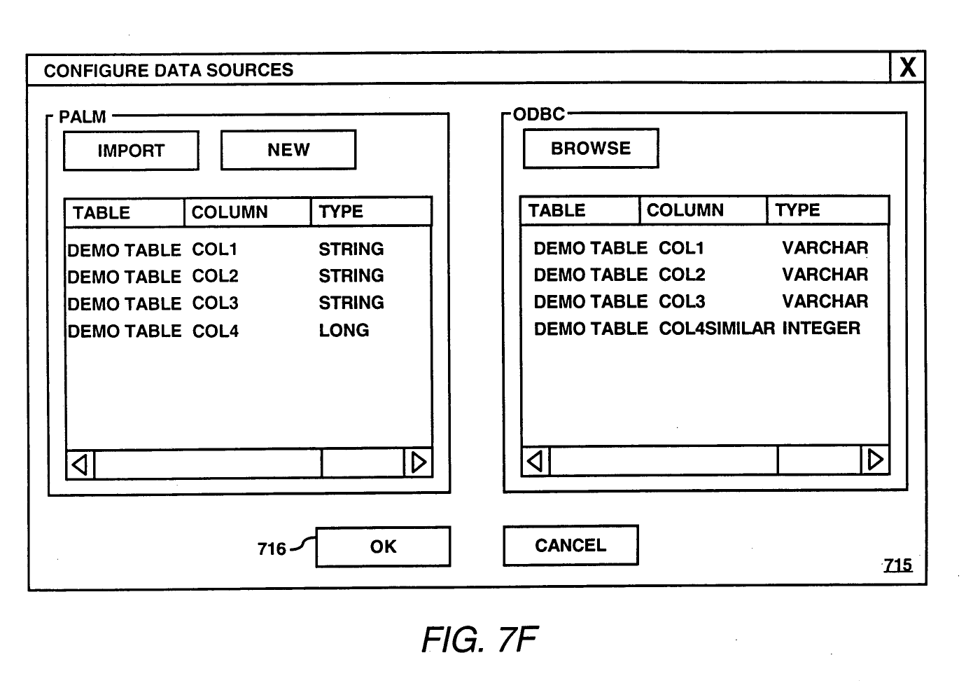

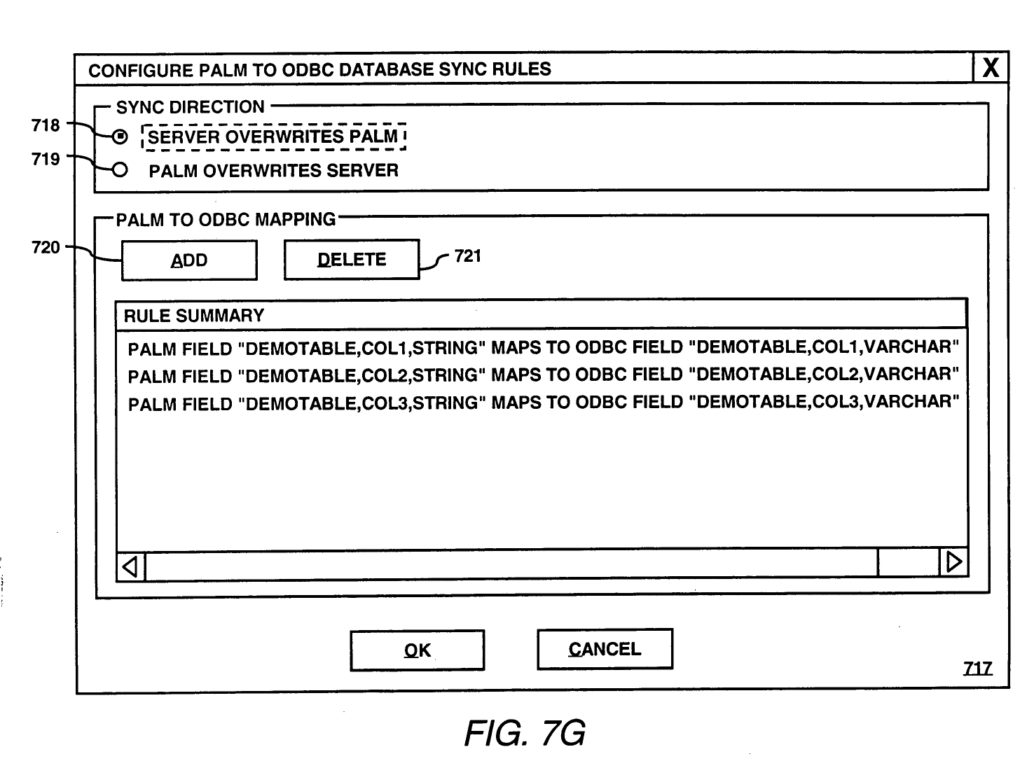

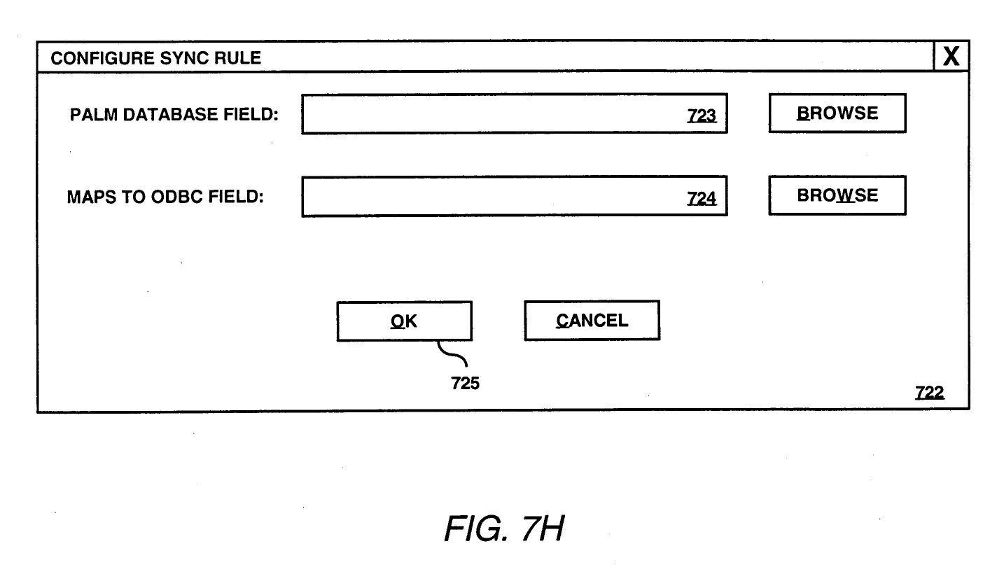

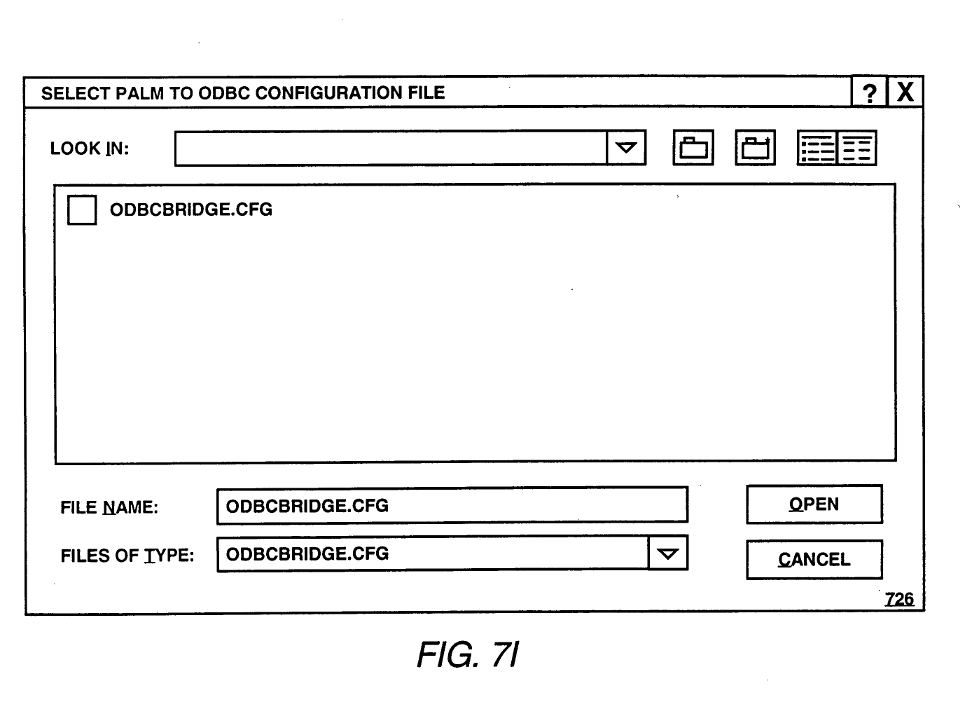

FIG. 6 illustrates an exemplary flow diagram 600 for an embodiment of the configurable conduit generator module 210 shown in FIG. 2 in accordance with the principles of the present invention. The steps of the flow diagram 600 may be further illustrated utilizing FIG. 7A-7I.

As shown in FIG. 6, in step 602, the configurable conduit generator module 210 may be initiated. The initiation may be event such as a GUI menu item selection, a command line prompt, an activation of an icon, or other similar activation event. An example of an initiation of the configurable conduit generator module 210 is depicted in FIG. 7A, which illustrates an example of a GUI 700 that may be used to activate the configurable conduit generator module 210. As shown in FIG. 7, a user may activate the configurable conduit generator module 210 from a menu item 702 (labeled as the ODBC SYNC WIZARD PLUG-IN) from a ‘Tool’ menu 704 on the GUI 700. Although, for purely illustrative purposes, FIG. 7A shows the configurable conduit generator module 210 being activated from a menu item from a tool menu, it should be readily apparent to those of ordinary skill in the art that the configurable conduit generator module 210 may be activated under other menus and other types of GUIs.

Returning to FIG. 6, in step 604, the driver module 405 of the configurable conduit generator 210 may be configured to display another GUI (e.g., a dialog box). The second GUI may be configured to provide the capability for a user to select a client database and an enterprise database such as an ODBC data source. Referring to FIG. 7B, an exemplary embodiment of the second GUI for selecting a client and enterprise databases is illustrated in accordance with principles of the present invention. As shown in FIG. 7B, a ‘Configure Data Source’ GUI 706 includes a PALM area 707 for the client database, PALM, and an ODBC area 708 for the enterprise database.

Referring to FIG. 6, in step 606, the driver module 405 may be configured to wait until a user to select the appropriate client and enterprise databases. If a user decides not to build a customize conduit, and the driver module 405 may be configured to end in step 608. Otherwise, for example, a user may select a client database by activating an ‘Import’ button 710 (see FIG. 7B) in the Palm area 707 of the Configure Data Source GUI 706. By activating the Import button 710, the driver module 405 may be configured to provide a user the capability to select a database formatted according to PALM standards. Subsequently, the driver module 405 may be configured to display yet another GUI for selection of the database formatted according to PALM standards. FIG. 7C illustrates an exemplary GUI 711 for selecting the database formatted according to PALM standards and FIG. 7D illustrates another exemplary GUI 712 for selecting the database formatted according to PALM standards.

Returning to FIG. 7B, by the activation of the ‘Browse’ button 713, the driver module 405 may be configured to display yet another GUI (e.g., a dialog box) for the selection of the enterprise database. FIG. 7E illustrates an exemplary ‘Select Data Source’ GUI 714 for the selection of the enterprise database (e.g., an ODBC database). After the selection of client and enterprise databases, the driver module 405 may be configured to display the fields (or columns) of the selected databases. FIG. 7F illustrates a populated Configure Data Source GUI 715 with exemplary fields of the selected databases.

Referring back to FIG. 6, in order to complete the selection process of step 606, a user may activate a mechanism to signal to the conduit generator module 405 that the selection process is completed. For instance, a user may activate an OK button 716 on the populated Configure Data Source GUI 715 shown in FIG. 7F.

In step 610, the driver module 405 may be configured to process the selected databases by applying a preliminary column-mapping rule In particular, the driver module 405 may invoke the preliminary mapping module 420 to map one field of a client database to a respective field of an enterprise database by a preliminary mapping rule of matching similar names. The driver module 405 may be also configured to display the result of the preliminary mapping by the preliminary-mapping module 420. For example, FIG. 7G illustrates a ‘Configure PALM to ODBC database sync rules’ GUI 717 with a set of mapping rules in accordance with an embodiment of the present invention. As shown in FIG. 7G, a synchronization direction may be specified for the displayed rule set. In particular, synchronization by writing data from the enterprise database over the client database may be selected by activating a radio button 718. Synchronization by writing data from the client database over the enterprise database may be selected by activating a second radio button 719.

Returning to FIG. 6, in step 612, the driver module 405 may be configured to provide the capability for a user to modify the displayed set of preliminary mapping rule set by invoking the rule modification module 425. In particular, if a new mapping rule were to be added in step 614, a user may activate an Add button 720. The driver module 405 may be further configured to invoke the rule modification module 425 to generate yet another GUI to provide the capability to add new rules to the current preliminary mapping rule set. FIG. 7H illustrates an exemplary ‘Configure Sync Rule’ GUI 722 for adding a new rule to the preliminary mapping rule set as displayed by the driver module 405. As shown in FIG. 7H, the Configure Sync Rule GUI 722 includes a ‘PALM Database Field’ window 723 configured to provide an entry window for a user to input a select field of the client database. The Configure Sync Rule GUI 722 includes a ‘Maps to ODBC Field’ window 724 configured to provide an entry window for a user to input a respective field of the enterprise database. Subsequently, the driver module 405 may be further configured to add and display the inputted new rule on the ‘Configure PALM to ODBC database sync rules’ GUI 717 in response to an activation of an ‘Okay’ button 725 on the Configure Sync Rule GUI 722. Of course, this particular process may be repeated until all the necessary rules are added to the preliminary mapping rule set.

Returning to FIG. 6, if a mapping rule were to be deleted, in step 616, a user may select an existing rule in the preliminary mapping rule set and activate a mechanism for deleting the selected rule. The driver module 405 may invoke the rule modification module 425 to g provide the capability for a user to delete an existing rule. For example, in FIG. 7G, a user may activate a ‘Delete’ button 721 to delete a selected or highlighted rule. A user may repeat rule deletion process until all the rules are deleted if so desired.

Once the modifications to the preliminary mapping rule set are complete, in step 618, the driver module 405 may be configured to display yet another GUI to provide the capability for a user to save the preliminary mapping rule set to a persistent memory storage device (e.g., a disk drive, a network storage, etc.). FIG. 7I illustrates an exemplary ‘Save Configuration File’ GUI 726 for saving the preliminary mapping rule set, which may be designated as a configuration file.

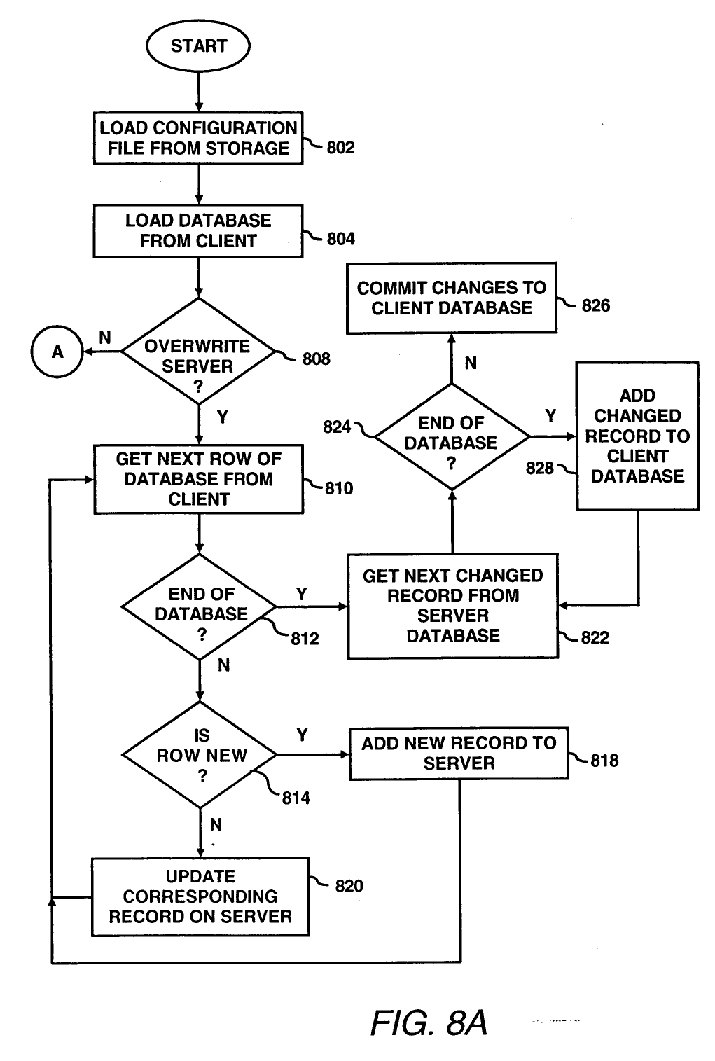

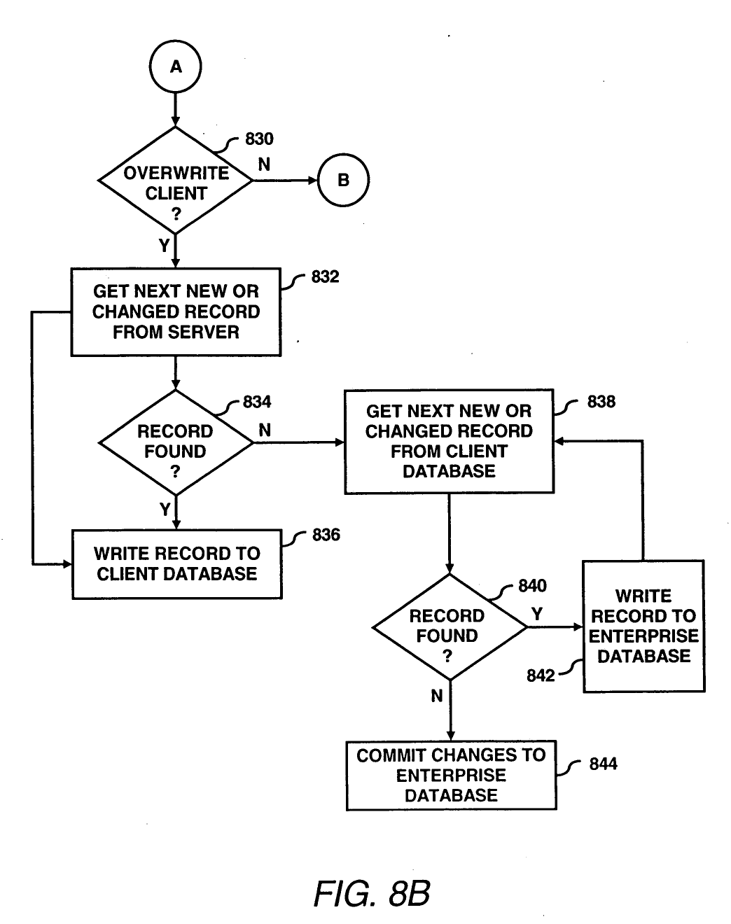

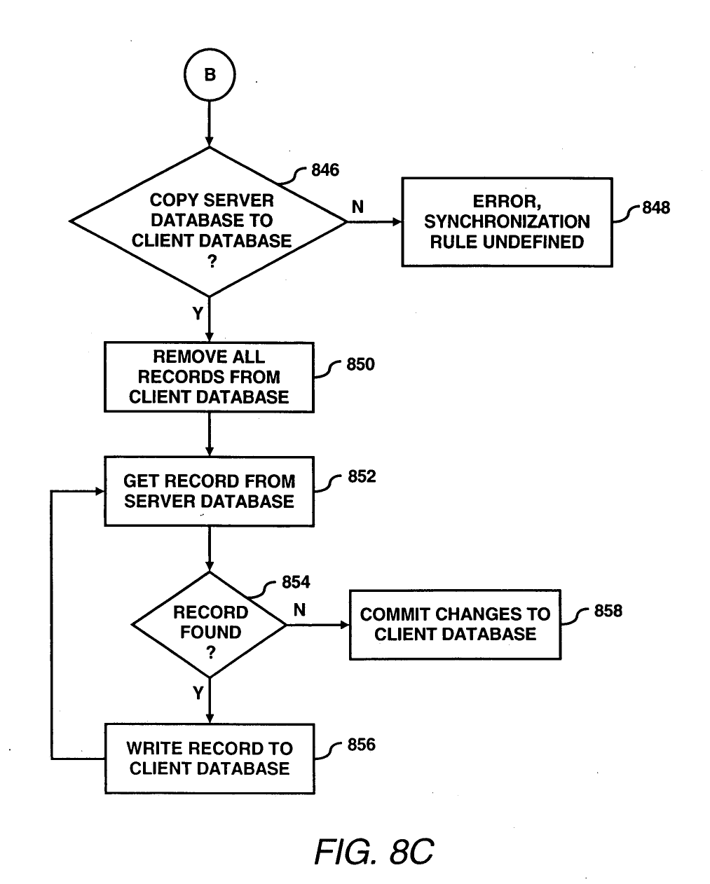

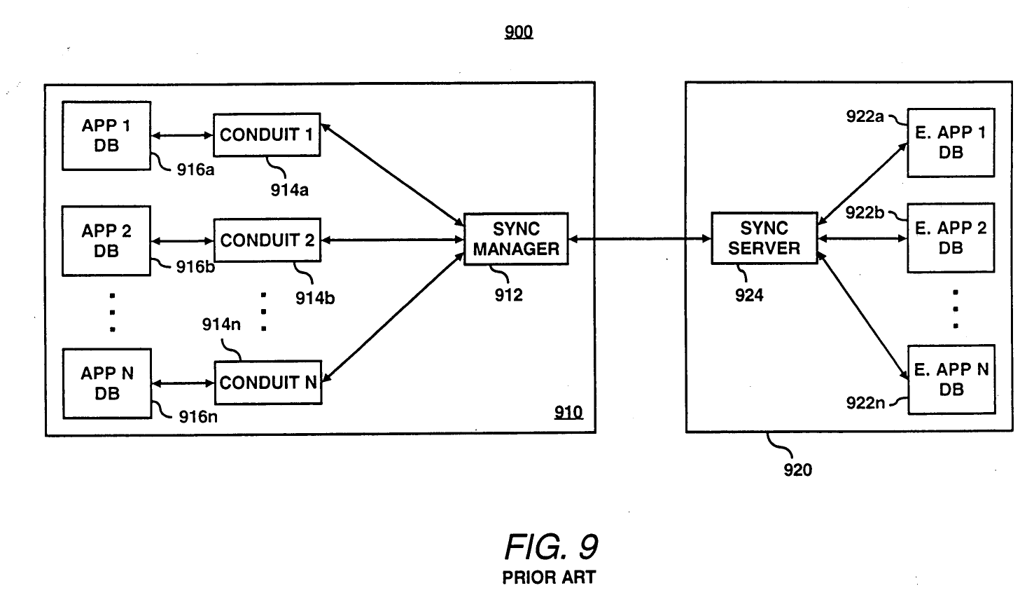

FIGS. 8A-8C collectively illustrate a flow diagram for synchronizing data or information in accordance with the concepts of the present invention is now described with reference to FIG. 1. As shown in FIG. 8A, after a synchronization request has been executed, for example at either client 110 or enterprise server 120, the mapping rule sets are retrieved by, for example, the configurable conduit 116 (step 802). As the mapping rule sets are executed, the identified database specified in one set of the mapping rule is loaded from the client (step 804). In addition, other user-determined configuration information relating to synchronization may also included with the rules such as, for instance, an overwrite policy.

If the overwrite policy indicates that data in enterprise server 120 is to be overwritten by data stored in client 100 (step 808), processing continues with the retrieval of a row of information or data from the previously loaded database from the client 110 (step 810). With each row, the configurable conduit 116 initially determines whether the end of the database has been reached (step 812). If not, the configurable conduit 116 then determines whether the row is new (step 814). If the row is not new, any changes or modifications to the row retrieved from the client 110, since the last synchronization, may be implemented to the corresponding row stored in enterprise server 120 (step 820). If no changes or modifications have been made since the last synchronization, no update is necessary. On the other hand, if the row is new, a new record is added to the database stored in enterprise server (step 818). Subsequently, the process returns to the step 810.

Returning to step 812, upon reaching the end of the client database, a row of information that has been changed is retrieved from the database stored in enterprise server 120 (step 822). As with the above, with each row, the configurable conduit 116 initially determines whether the end of the database has been reached (step 824). If not, any changes or modifications to the row retrieved from enterprise server 120, since the last synchronization, may be implemented to the row stored in client 110 (step 828). If no changes or modifications have been made since the last synchronization, no update is necessary. This process continues until the end of the enterprise database is reached. At that time, the updates and changes may be committed to the client database (step 826).

Referring to FIG. 8B, if the overwrite policy indicates that data in client 110 is to be overwritten by data stored in enterprise server 120 (step 830), processing continues with the retrieval of a row of changed or new information or data from a database located or stored in enterprise server 120 (step 832). Thus, only rows of information that have been updated or modified since the last synchronization are retrieved. If such a row is located (step 834), it may then be written to a corresponding database stored in client 110 (step 836).

Returning to step 834, once all of the modified or changed rows from enterprise server 120 have been located, processing continues with the retrieval of a row of changed or new information or data from a database located or stored in client 110 (step 838). Again, only rows of information that have been updated or modified since the last synchronization are retrieved. If the configurable conduit 116 is successful in locating a recently modified row of information (step 840), the row may be written to a corresponding database stored in enterprise server 120 (step 842). This process then continues until all of the recently modified rows of information have been updated to enterprise server 120. At that point, the updates and changes may be committed to the enterprise database (step 844).

Referring to FIG. 8C, if the overwrite policy indicates that the client database is to be completely overwritten by a corresponding enterprise database (step 846), processing continues with the removal of all rows from the client database (step 850). Subsequently, a row is retrieved from the corresponding enterprise database (step 852). If the configurable conduit 116 is successful in retrieving a row (step 854), then that row may be written to the database stored in client 110 (step 856). This process continues until all rows from the enterprise database have been copied to client 110. Once all of these rows have been copied, the updates and changes may be committed to the enterprise database (step 858). Returning to step 846, if an undefined overwrite policy is identified, an error message may be returned to the user (step 848).

In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using C, C++, or Visual Basic (Microsoft) s programming languages.

While the invention has been described with reference to the exemplary embodiments thereof, those skilled in the art will be able to make various modifications to the described embodiments of the invention without departing from the true spirit and scope of the invention. The terms and descriptions used herein are set forth by way of illustration only and are not meant as limitations. In particular, although the method of the present invention has been described by examples, the steps of the method may be performed in a different order than illustrated or simultaneously. Those skilled in the art will recognize that these and other variations are possible within the spirit and scope of the invention as defined in the following claims and their equivalents.

1-45. (canceled)

46. A method of making conduits, comprising:
providing a configurable conduit; and
providing a mapping rule set;
wherein a single said configurable conduit is modified by said mapping rule set for use with multiple applications.

47. The method of making conduits as recited by claim 46 wherein:
said mapping rule defines mapping of fields between at least two databases.

48. The method of making conduits as recited by claim 46, wherein:
said configurable conduit is created with a configurable conduit generator module.

49. The method of making conduits as recited by claim 48, wherein:
said configurable conduit generator module relies on a graphical use interface (GUI) to create said configurable conduit.

50. The method of making conduits as recited by claim 49, wherein:
said GUI provides a point-and-click environment to create the configurable conduit.

51. The method of making conduits as recited by claim 50, wherein:
said GUI allows selection of at least two databases.

52. The method of making conduits as recited by claim 49, wherein:
said GUI provides allows mapping of fields between at least two databases.

53. The method of making conduits as recited by claim 46, wherein:
said mapping rule set is pre-defined.

54. The method of making conduits as recited by claim 46, wherein:
said mapping rule set is user-defined.

55. A system for making conduits, comprising:
a configurable conduit; and
a mapping rule set;
wherein a single said configurable conduit is modified by said mapping rule set for use with multiple applications.

56. The system for making conduits as recited by claim 55 wherein:
said mapping rule defines mapping of fields between at least two databases.

57. The system for making conduits as recited by claim 55, wherein:
said configurable conduit is created with a configurable conduit generator module.

58. The system for making conduits as recited by claim 57, wherein:
said configurable conduit generator module relies on a graphical use interface (GUI) to create said configurable conduit.

59. The system for making conduits as recited by claim 58, wherein:
said GUI provides a point-and-click environment to create the configurable conduit.

60. The system for making conduits as recited by claim 59, wherein:
said GUI allows selection of at least two databases.

61. The system for making conduits as recited by claim 58, wherein:
said GUI provides allows mapping of fields between at least two databases.

62. The system for making conduits as recited by claim 55, wherein:
said mapping rule set is pre-defined.

63. The system for making conduits as recited by claim 55, wherein:
said mapping rule set is user-defined.

64. Apparatus for making conduits, comprising:
means for providing a configurable conduit; and
means for providing a mapping rule set;
wherein a single said configurable conduit is modified by said mapping rule set for use with multiple applications.

65. The apparatus for making conduits as recited by claim 64 wherein:
said mapping rule defines mapping of fields between at least two databases.

66. The apparatus for making conduits as recited by claim 64, wherein:
said configurable conduit is created with a configurable conduit generator module.

67. The apparatus for making conduits as recited by claim 66, wherein:
said configurable conduit generator module relies on a graphical use interface (GUI) to create said configurable conduit.

68. The apparatus for making conduits as recited by claim 67, wherein:
said GUI provides a point-and-click environment to create the configurable conduit.

69. The apparatus for making conduits as recited by claim 68, wherein:
said GUI allows selection of at least two databases.

70. The apparatus for making conduits as recited by claim 67, wherein:
said GUI provides allows mapping of fields between at least two databases.

71. The apparatus for making conduits as recited by claim 64, wherein:
said mapping rule set is pre-defined.

72. The apparatus for making conduits as recited by claim 64, wherein:
said mapping rule set is user-defined.
